(19) United States
(12) Patent Application Publication
(10) Pub. No.: US 2008/0272083 A1
(43) Pub. Date: Nov. 6, 2008

(54) Closure

(76) Inventor: Rodney M. Druitt, Cheltenham (GB)

Correspondence Address: OSTROLENK FABER GERB & SOFFEN, 1180 AVENUE OF THE AMERICAS, NEW YORK, NY, 100368403, US

(21) Appl. No.: 11/886,272

(22) PCT Filed: Apr. 7, 2005
(86) PCT No.: PCT/EP2005/051559

§ 371 Date: Apr. 14, 2008

Related U.S. Application Data
(60) Provisional application No. 60/661,983, filed on Mar. 14, 2005.

(51) Int. Cl. B65D 41/34; B65D 41/04; B29C 45/14

(52) U.S. Cl. 215/252; 215/253; 264/263; 264/250

(57) ABSTRACT

The present invention is directed to a closure for container. The closure comprises an outer shell, made out of a shell material, with a top portion and an outer skirt with an internal thread. The closure further comprises a sealing-liner, made out of a liner material, with at least one downward leg. In the process to make to closure the sealing-liner is made first.

### FIELD OF THE INVENTION

The herein disclosed invention is directed to a closure, especially a two component closure, a seal for a closure and a tamper evidence solution for a closure.

### BACKGROUND OF THE INVENTION

A closure known in general as the HC Industries Alcoa lined wing lock design closure has been commercially applied on carbonated soft drink (CSD) PET products for more than 20 years. At the time of its conception plastic closures generally had no tamper evidence available in their design, those that had, required elaborate, expensive and inefficient heat shrink tunnels to produce tamper evidence function ability.

Closures are generally manufactured from several types of plastic, such as Polyethylene (from now on PE) or Polypropylene (from now on PP) or EVM-based materials such as Direx. The latter is used for the shell manufacture of liner closures; the material is harder and less durable than PE. Softer material such as Low density PE (LDPE), ethylene vinyl acetate (EVA) or compounds based on polyolifynic raw materials are often used as liner material. More rigid materials such as Polypropylene are often used as a shell material of closures.

U.S. Pat. No. 4,497,765 is directed to a closure-making process and apparatus for the production of plastic closures. The closures according to US'765 includes a plastic closure cap which is compression moulded. The process includes steps for formation of a sealing liner within the closure cap if desired, with formation of a liner-retaining arrangement provided for secure retention of the liner within the cap. The liner forms an undercut in the outer area and is therefore difficult to demold. The sealing liner is formed by pressing a certain amount of liner material into an existing outer.

EP0224649 is directed to a plastic closure having a self-engaging locking pilfer band arrangement for engagement with a locking ring on the neck of a container to which the closure is applied. The pilfer band includes a plurality of circumferentially spaced, inwardly extending relatively thin and therefore week flexible wings which move to an out-of-the-way position during application of the closure to the container. The closure comprises a sealing liner which is formed by compression moulding after the outer shell has been produced.

U.S. Pat. No. 5,320,234 describes a tamper-indicating plastic closure with an annular pilfer band partially detachably connected to the skirt portion of the closure, whereby the pilfer band remains connected to the closure after closure removal from an associate container. The pilfer band includes a fracturable region which fractures during closure removal, whereby the pilfer band splits and separates. The fracturable region is defined by a pair of circumferentially and vertically spaced, staggered scores which are configured to facilitate high-speed manufacture, and consistent tamper-indication.

### SUMMARY OF THE INVENTION

As it becomes obvious from the above cited prior art, e.g. such as described in U.S. Pat. No. 4,497,765, two piece closures are known from prior art which in general are made by compression moulding. The outer shell of these closures is made first and the liner is then formed in a separate step by pressing a kneadable material in the outer shell of the closure by a die-punch. Due to the manufacturing process the geometry and the tamper evidence of these closures is limited and these closures may not be equipped by an efficient bore seal which reaches sufficiently into the opening of the neck of the container to be sealed.

Two piece closures are known from prior art which comprise a liner which is made separate of the closure and then implemented into the outer shell of the closure by an appropriate process. These closures also have only a limited geometry and tamper evidence and may not be equipped by an efficient bore seal. One draw back is that no sufficient interconnection between the liner and the outer shell are achievable.

The present invention is directed to an improved form of a two component closure cap comprising an outer shell and a liner.

The closure according to the present invention is preferably made by an injection moulding process, respectively two-component injection moulding, in a single multi-component mould whereby a sealing liner with or without a downward leg (bore-seal and/or outside seal) is made in that a first plastic material is injected in liquid form into a first cavity onto a core of a mould cavity where the first material forming the liner congeals. Afterwards the solid liner is displaced with the first core into a second cavity position wherein a second material for an outer shell of the closure is injected into the second cavity forming at least a disc like top portion, an outer skirt and a tamper band of the closure. The material of the sealing-liner and the material of the outer shell are thereby integrally joined to each other.

To optimise the production process the area in the cavity of the sealing-liner which is not in contact with the first core is preferably shaped such that the sealing-liner can be taken out of the first cavity without retaining forces. Therefore hindering undercuts mainly extending perpendicularly with respect to the displacing direction or the core are avoided. By the described injection moulding process a firm bonding is obtained between the liner and the shell material. In difference to the closures as known from prior art made by a compression moulding process, the herein disclosed invention results in more reliable seal. Problems which typically occur when demoulding of closures made by compression moulding, where the shell of the closure is made first and the sealing liner second, do not occur with the herein described invention.

A preferred embodiment of the closure comprises an outer shell with a disc like top portion and a therewith adjacent outer skirt and interlocking means such as an internal thread suitable to be engaged with the external thread of a standardized neck of a PET or glass container as known from prior art or a circumferential undercut. The outer shell is preferably made out of Polypropylene (PP) or High Density Polyethylene (HDPE) whereby the liner is formed out of a softer material such as EVA, LDPE or a compounded material based on polyolefinic raw materials. The embodiment of the closure further comprises a sealing means which interacts with an outer thread-free peripheral cylindrical surface arranged between the thread and the annular top surface of the neck of the container.

The closure may further comprise a tamper evidence band integrally interconnected to the lower end of the outer skirt of the closure, e.g. by tearable bridges. The tamper evidence band comprises undercut segments arranged substantially radially inwardly to be engaged with a tamper evidence bead of the neck of a bottle creating an improved contact upon opening of the closure. In a pre-ferred embodiment centring elements are arranged above the undercut segments guaranteeing that the undercut segments and the tamper evidence bead of the neck of the bottle are coaxially aligned to each other. The centring elements may be designed and arranged such that they ease the ejection of the undercut segments in that they work as ramps.

In a preferred embodiment the thread of the closure according to the present invention is made such that failure of the seal due to mismatch of the closure during application of the closure on to the neck of the container becomes more unlikely compared to closures known from prior art. The thread consists out of segments wherefrom several segments are having an essentially frusto conical/prolate ellipsoidal bottom (lower end section which points in the direction of the opening of the closure) and an essentially conical shape at their top. The conical top shape is aligned to the pitch of the thread such that it interacts along its length with the thread of the neck of the container when engaged. To obtain good distribution of load it is advantageous that segments of the thread interact with the thread of the neck of the container two-dimensional. The effect of the frustoconical shape of the bottom of the segments is that during application of the closure onto the thread of the neck of the container the contact between the segments of the thread of the closure and the thread of the neck of the bottle occurs due to the specific bottom shape of the segments of the thread only at distinct interaction points. A further advantage is that drag during ejection out of the production mould is, compared to threads known from prior art, significantly reduced. Looking at a radial cross section of a segment of the thread of the closure, the cross section comprises an essentially arch-shaped bottom and an essentially straight top which passes over into an essentially vertical inner side surface of the closure. The transitions from one segment of the cross section into another are preferably floating without sharp edges. The dilation of the cross sections of the segments of the thread is in general maximal about the middle of the length of each segment and is reduced versus its ends. At least one of the first (inlet of the thread) and the last (outlet of the thread) segments may have a shape which deviates from the shape of the other segments. Thereby the special conditions on the beginning and the end of the thread are considered.

The sealing means of the preferred embodiment of the closure comprises an essentially downward leg shaped cylindrical inner skirt arranged inside the outer skirt extending perpendicular from the annular top surface into the closure radially distanced to the outer skirt and made out of the material of the outer shell of the closure and/or the liner. The inner skirt is at its base preferably interconnected directly to the top portion of the closure. Depending on the filed of application the leg shaped inner skirt may be functionally or rigidly interconnected to the outer skirt of the closure. However, this may implicate that the closure is not as flexible with respect to adjusting on radial distortion of the neck of the bottle. Inside the inner skirt a liner is arranged which is formed out of the same or a different material as the outer shell of the closure. The liner is preferably made out of a softer material than the outer shell of the closure. Good results have been achieved with various soft lining materials such as LDPE, EVA and compounds such as a material know as “Darex”. The inner skirt of the closure is designed such that it supports the liner from the outside without negatively hindering the adjustability. The liner and the outer shell of the closure are preferably made our of materials which are joining due to injection moulding.

With respect to it's cross-section the sealing-liner preferably comprises an outer downward leg extending at least partially along the inner skirt of the outer shell. The outer downward leg of the liner or the inner skirt of the outer shell may comprise at its free end an in general toroidal sealing ring which interacts in closing position of the closure on the neck of a container radially from the outside with an in general cylindrical outer free surface, arranged between the annular top surface and the start of the outside thread of the neck of the container, via a designated contact surface. The contact surface is arranged preferably as far down onto the free surface of the neck of the bottle as possible to reduce influence of deformation, e.g. doming, bottle finish damage at the upper outside rim, lifting of closure, of the closure which might occur. The toroidal sealing ring is preferably shaped such that it seals primarily due to annular tension. Therefore the toroidal sealing ring comprises an annular protrusion which is arranged in engaged position towards the neck of the container. In difference to seals known form prior art which act on the inside surface of the neck and therefore are mainly subject to annular pressure forces, the toroidal sealing of the present embodiment mainly seals due to annular tension forces. By the design of the sealing means contact and defined interaction with the outer skirt of the closure may be appropriate depending on the field of application although adjustability to radial distortion of the neck of a container is reduced.

Depending on the field of application the sealing-liner further comprises a top seal which interacts with an annular top-surface of the neck of the container and/or a bore seal which reaches into the opening of the neck of the container. In difference to the prior art the present invention offers the opportunity to develop specific undercut regions aligned with respect to the neck of the container and forming contact zones of increased interaction between the sealing means and the neck of the container. One advantage of the herein disclosed sealing means consists in the improved performance of the sealing means when applied on damaged bottle neck finishes. Especially due to the reason that the described sealing means do interact with the neck finish in areas which normally are quiet unlikely to be damaged.

In a preferred embodiment the downward leg and/or the inner skirt comprise in the area of it's lower free end at least one annular sealing ring which interacts in the closing position of the closure on the neck radially from the outside with an in general cylindrical outer free surface of the neck of the container via a designated contact surface.

The sealing means of a preferred embodiment is designed such that it is capable to adjust/compensate a certain amount of lateral and/or radial offset or distortion of the neck of the container. Therefore it comprises a base which provides a certain flexibility in lateral/radial direction. Good results are achieved in that the proportion ratio vertical length to radial thickness of the base of the sealing means, which is arranged between the top portion of the closure and the toroidal sealing ring, is at least 1:1 preferably 4:1. Depending on the field of application further aspect ratios are relevant such as the radial thickness of the base of the sealing means and the radial thickness of the annular sealing ring and the aspect ratio of the vertical length to the radial thickness of the annular sealing ring. The aspect ratio of the vertical length of the annular sealing ring to its radial thickness mainly influences the annular tension in the annular sealing ring and the contact force between the annular sealing ring and the neck of a container. In a preferred embodiment the aspect ratio between the radial thickness of the annular sealing ring and the base is in the range of 2:1 and 3:1 (depending on the field of application other aspect ratios may be appropriate). The aspect ratio between the vertical length of the annular sealing ring and its radial thickness is preferably in the range of 1:1 and 4:1. Depending of the field of application other aspect ratios are appropriate. The shape of the cross section of the annular sealing ring and the eccentricity of the contact surface with respect to the base of the sealing means is of further relevance for the field of application because these parameters influence the distribution of annular tension forces. The seal may comprise on the inside a liner made out of a gas tight material avoiding diffusion.

The liner is preferably formed such that it partially extends along the inner contour of the inner skirt Depending on the field of application the liner may comprise an inside bore seal which extends into the neck of the closure. Depending on the filed of application the inner skirt and/or the outer downward leg of the liner may be functionally interconnected with the outer skirt of the closure. If appropriate the closure can comprise a base and a lid which is mechanically interconnected to the base by a hinge.

### BRIEF DESCRIPTION OF THE DRAWINGS

The closure according to the present invention is explained in more detail according to a preferred embodiment.

FIG. 1 shows a closure according to the present invention in a perspective view from above;

FIG. 2 shows the closure in a top view;

FIG. 3 shows a cut view through the closure along line DD of FIG. 2;

FIG. 4 shows detail E according to FIG. 3;

FIG. 5 shows detail F according to FIG. 3.

### DETAILED DESCRIPTION OF PREFERRED EMBODIMENTS

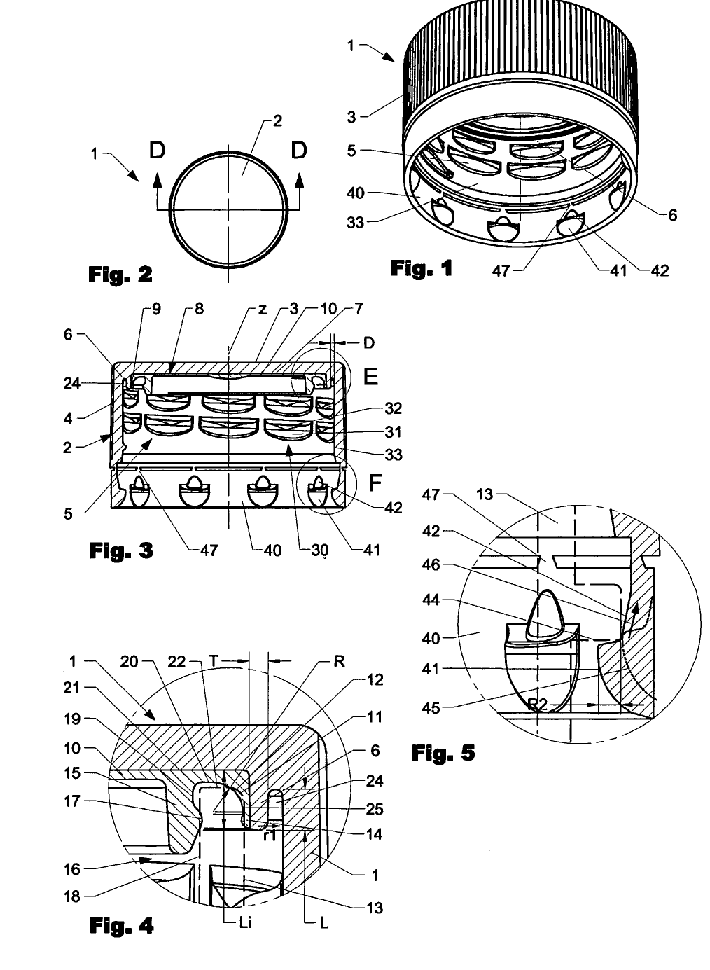

FIG. 1 shows a preferred embodiment of a closure according to the present invention in a perspective and FIG. 2 in a top view. FIG. 3 shows a cross cut through the closure according to FIG. 2 along line DD. FIG. 4 and FIG. 5 are showing details E and F of FIG. 3.

An outer shell 2 of closure 1 comprises a disc like top portion 3, an outer skirt 4 with an internal thread 5 and a ring-shaped inner skirt 6 which is arranged essentially concentrical to the outer skirt 4 at a distance D extending perpendicular from an inner surface 7 of the top portion 3. The shown closure 1 further comprises a sealing-liner 8 with a liner disc 10, which extends horizontally along the inner surface 7 of the top portion 3 and blends into a downward leg 9, which here extends downwardly along the inner skirt 6 and is supported by that.

The outer shell 2 of the closure 1 is preferably made out of Polypropylene (PP) or High Density Polyethylene (HDPE) whereby the sealing liner 8 is preferably formed out of a softer material. Depending on the field of application it is possible due to the type of process to make the closure out of PP or PE or one or several other appropriate materials.

As visible in FIG. 4, which shows detail E of FIG. 3, a first blend 11 between downward leg 9 and the liner disc 10 of the herein shown embodiment comprises a radius R which in the described embodiment sealingly interacts in a closing position of the closure 1 with an outer top surface 12 of a neck 13 of a container. The downward leg 9 comprises at its lower free end a first annular sealing ring 14 protruding radially inwardly and which interacts in a closing position with an outer cylindrical top surface 25 of the neck 13 from the outside. The toroidal sealing ring 14 and the inner skirt 6 are shown in an undeformed manner but will be extended radially outwardly in the direction of arrow r1 during application onto the neck 13. Thereby, depending on the field of application, the design of gap 24 is chosen such that no interaction takes place between the inner skirt 6 and the outer skirt 4 of the closure 1. The supporting of the downward leg 9 by the inner skirt 6 is adjusted by the free length L and the thickness T of the inner skirt 6, respectively the depth L and the radial extension D of gap 24. As it can be seen the outer free length L is in the shown embodiment bigger than the inner free length Li. This results in that the lateral support of the inner skirt 6 is bigger in the area of it's base compared to it's free end.

The sealing liner 8 further comprises a bore seal 15 which extends downwardly into the opening 16 of the neck 13 as a second downward leg. The bore seal comprises here a second annular sealing ring 17 protruding radially outwardly interacting in a closing position with the inner surface 18 of neck 13. The second annular sealing ring 17 is shown in an undeformed manner but will be deformed radially inwardly during application onto neck 13. In the shown embodiment the bore seal 15 comprises an in general vertical base area 19 on its outside between the liner disc 10 and the second annular sealing ring 17. A second blend 21 between the base are 19 and an intermediate top surface 20, which is forms the transition between the bore seal 15 and the downward leg 9, is formed here such that no interaction with the neck 13 takes place in a closing position. However, if appropriate the second blend 21 may be designed such that interaction with the neck 13 takes place in this area. If appropriate the intermediate top surface 20 comprises an in general v-shaped protrusion which forms a top seal and interacts in the closing position with an annular top surface 22 of neck 13.

As it can be seen the first and the second annular sealing ring 14, 17 are forming radially arranged undercuts, directed to the neck 13 of the container, which are under normal conditions difficult to take out of the mould. It has been shown that the design of the downward leg 9 and the bore seal can be demoulded without any drawback by the process described herein. In a further embodiment the outer downward leg 9 and the inner downward leg 15 are arranged at an angle to the top portion 3 having an in general conical shape with an in general parallel and/or decreasing radial thickness in the direction of their lower free end. This second embodiment provides more simple demoulding with certain materials. The inner downward leg 15 may be arranged extending from it's base on radially outwardly forming a contact point for interaction with the inner surface of the neck 13. By the choice of an appropriate soft material the inner downward leg 15 is deformed due to inner pressure, acting on the inside of the downward leg 15, radially outwardly supporting the sealing performance in relation to the inner pressure.

The internal thread 5 of the shown embodiment comprises here essentially similar thread segments 30 with an essentially frusto conical/prolate ellipsoidal bottom 31 and an essentially conical shape at their top 32, which is aligned to the pitch of the thread 5 such that it interacts along its length with the thread of the neck 13 (not shown in detail) when in closed position. One effect of the frusto conical shape of the bottom 31 of the segments 30 is that during application of the closure 1 onto the thread of the neck 13 the contact between the segments 30 and the thread of the neck 13 primarily only at distinct interaction points. A effect of the thread segments 30 is that drag during ejection out of the production mould is, compared to threads known from prior art, significantly reduced. The closure can more easily be strained. Looking at a radial cross section of a segment of the thread of the closure, the cross section comprises the essentially arch-shaped bottom 31 and the essentially straight top 32 which passes over into an essentially vertical inner side surface 33 of the closure. The transitions between the segments 30 and the inner side surface 33 is preferably rounded of by blends.

As it can be seen in FIGS. 3 and 5 the described closure 1 comprises a tamper band 40 which comprises undercut segments 41 protruding radially inwardly and having an in general round lateral cross-section (cross-section perpendicular to the axis z of the closure 1). Above the undercut segments 40 centring elements 42 are arranged which are here in general aligned to the closure axis z and which help to centre the closure 1 with respect to a locking bead 44 of the neck 13 of a container. The radial extension of the centring elements 42 is decreasing in the direction of the disc like top portion 3 and their lateral cross-section (cross-section perpendicular to the axis z of the closure 1) is suitable to receive the undercut segments 41 during ejection of the closure 1 out of the mould. The centring elements 42 are therefore not only coaxially positioning the tamper band 40 with respect to the neck 13 but also working as a ramp during ejection out of the mould (schematically displayed by stroke-dotted line 45 and arrow 46 indicating ejection. One advantage is that the tamper band 40 initially only has to be stretched radially by the free depth R2 of each undercut segment 41. In the here shown embodiment the centring elements 42 have in general a lateral cross-section which corresponds with the lateral cross-section of the undercut segments 41. The tamper band 40 is interconnected to the outer skirt 3 by tearable bridges 47. The bridges are in the herein shown closure 1 aligned with the undercut segments 41 which avoids negative influence during ejection.

1. Closure for a container comprising an outer shells, made out of a shell material, with a top portion, an outer skirt, interlocking means and a sealing-liner, made out of a liner material, and with at least one downward leg.

2. The closure according to claim 1, wherein inside the outer shell a ring-shaped downward leg is arranged extending in general perpendicular from an inner surface of the top portions, whereby the downward leg is arranged essentially concentrically to the outer skirt spaced apart from the outer shell by a gap having a radial thickness D and a vertical length L.

3. The closure according to claim 2, wherein the downward leg is an inner skirt of the outer shell which radially supports an outer downward leg of the sealing-lines.

4. The closure according to claim 2, wherein the downward leg and/or the inner skirt comprise in the area of their lower free end at least one annular sealing ring which interacts in the closing position of the closure on the neck radially from the outside with an in general cylindrical outer free surface of the neck.

5. The closure according to claim 2, wherein the downward leg blends into a liner disc of the sealing-liner by a blend having a radius R such that it sealingly interacts in a closing position of the closure with an outer top surface of a neck.

6. The closure according to claim 1, wherein the sealing-liner comprises an in general V-shaped top seal.

7. The closure according to claim 1, wherein the sealing-liner comprises a bore seal.

8. The closure according to claim 7, wherein the bore seal comprises an annular sealing ring.

9. The closure according to claim 7, wherein the bore seal is arranged essentially perpendicular with respect to the top portion of the closure.

10. The closure according to claim 7, wherein the bore seal is arranged at an angle with respect to the top portion of the closure extending radially outwardly with respect to it's lower end.

11. The closure according to claim 1, wherein the closure comprises a tamper band with undercut segments and centring elements arranged above the undercut segments.

12. The closure according to claim 1, wherein the interlocking means are either circumferential undercut and/or a thread.

13. The closure according to claim 11, wherein the centring elements have a lateral cross-section suitable to receive the undercut segments during ejection.

14. The injection moulding process for the production of a closure having at least one downward leg according to claim 1, comprising the following steps:
a) Making of a sealing-liner in that a first plastic material is injected in liquid form into a first cavity onto a core;
b) The sealing-liner is displaced with the first core into a second cavity position;
c) A second material is injected into the second cavity forming an outer shell of a closure, whereby the material of the sealing-liner and the material of the outer shell are integrally joined to each other along an outer free area of the sealing-liner.

15. The injection moulding process according to claim 14, wherein during the making of the sealing-liner, beside a liner-disc at least one downward leg are formed.

16. The injection moulding process according to claim 15, wherein the at least one downward leg is made as an outer downward leg or a bore seal.

17. The closure according to claim 3, wherein the downward leg and/or the inner skirt comprise in the area of their lower free end at least one annular sealing ring which interacts in the closing position of the closure on the neck radially from the outside with an in general cylindrical outer free surface of the neck.

18. The closure according to claim 4, wherein the downward leg blends into a liner disc of the sealing-liner by a blend having a radius R such that it sealingly interacts in a closing position of the closure with an outer top surface of a neck.

19. The closure according to claim 8, wherein the bore seal is arranged essentially perpendicular with respect to the top portion of the closure.
